(19) United States
(12) Patent Application Publication
(10) Pub. No.: US 2005/0064897 A1
(43) Pub. Date: Mar. 24, 2005

(54) Dual band transmitting/receiving device

(75) Inventors: Kazunori Nohara, Shiga (JP); Setsuya Oku, Shiga (JP)

Correspondence Address: FOLEY AND LARDNER;SUITE 500, 3000 K STREET NW, WASHINGTON, DC, 20007, US

(73) Assignee: NEC Compound Semiconductor Devices, Ltd.

(21) Appl. No.: 10/944,908

(22) Filed: Sep. 21, 2004

(30) Foreign Application Priority Data
Sep. 22, 2003 (JP) 2003-329223

(51) Int. Cl. H04M 1/00

(52) U.S. Cl. 455/553.1; 455/552.1

(57) ABSTRACT

The present invention provides a dual band transmitting/receiving device, which can perform transmission and diversity reception with low insertion loss in that the number of switches for switching antennas is small. The dual band transmitting/receiving device is constituted such that transmitting/receiving dual band antennas 1 and 2 capable of being used in both of 5 GHz band used with IEEE 802.11a communication standard and 2.4 GHz band used with IEEE 802.11b communication standard are connected to respective transmitting circuits 7 and 9 and respective receiving circuits 8 and 10 used with respective communication standards, in a state where the above each signaling path between the each antenna and the each receiving circuit or transmitting circuit is connected via the only one switch. The antenna with high receiving level in the antenna itself can be selected in antenna selection of the diversity reception in such a way as to minimize the insertion loss caused by the switch while reducing the number of the switch, and the degree of magnitude of the insertion loss is made identical.

This application is based on Japanese patent application No. 2003-329223, the content of which is incorporated hereinto by reference.

### BACKGROUND OF THE INVENTION

1. Field of the Invention

The present invention relates to a dual band transmitting/receiving device capable of coping with both two frequency bands used in radio LAN or the like, and more particularly to a dual band transmitting/receiving device capable of carrying out diversity reception.

2. Description of Related Art

Recently, a radio LAN terminal is popularized swiftly in an office or a home. It is not necessary for the radio LAN terminal to provide a wiring for connecting the device, which is capable of accessing the radio LAN terminal with the radio. It is possible to utilize Internet or E-mail without selecting a position, in a state where only there are provided the radio LAN terminal, and a device capable of accessing the radio LAN terminal with the radio nearby. The previously spread standard IEEE 802.11b employs 2.4 GHz band frequency. In addition thereto, the terminal introduction with a standard of IEEE 802.11a of 5 GHz band advances. The terminal with the standard of IEEE 802.11a of 5 GHz band is capable of obtaining about 5 times transmission speed as compared with the former.

A dual band radio LAN terminal, which can use 2.4 GHz and 5 GHz in common so as to be able to cope with the both standards, is already commercialized from its user-friendliness.

Hereinafter, the conventional dual band transmitting/receiving device 200 is described with reference to FIG. 3. In FIG. 3, reference numerals 11 and 12 respectively indicate the first and the second antennas. The first antenna 11 and the second antenna 12 constitute a transmitting/receiving dual antenna, which is capable of being used to cope with both of 5 GHz band used with IEEE 802.11a communication standard and 2.4 GHz band used with IEEE 802.11b communication standard. Reference numerals 13 to 18 are switches for switching the antennas that are the single-pole double-throw switches each having one common terminal and two branch terminals as a terminal. Reference numeral 19 indicates the first transmitting circuit of the IEEE 802.11a communication standard, and reference numeral 20 indicates the first receiving circuit of the IEEE 802.11a communication standard. Reference numeral 21 indicates the second transmitting circuit of the IEEE 802.11b communication standard, and reference numeral 22 indicates the second receiving circuit of the IEEE 802.11b communication standard.

And, the first antenna 11 is connected to a common terminal of the switch 13. One branch terminal of the switch 13 is connected to a common terminal of the switch 15. The other branch terminal of the switch 13 is connected to one branch terminal of the switch 18. Further, the second terminal 12 is connected to a common terminal of the switch 14. One branch terminal of the switch 14 is connected to a common terminal of the switch 16. The other branch terminal of the switch 14 is connected to one branch terminal of the switch 17. Furthermore, one branch terminal of the switch 15 is connected to the first transmitting circuit 19. The other branch terminal of the switch 15 is connected to the other branch terminal of the switch 17. A common terminal of the switch 17 is connected to the first receiving circuit 20. Moreover, one branch terminal of the switch 16 is connected to the second transmitting circuit 21. The other branch terminal of the switch 16 is connected to the other branch terminal of the switch 18. A common terminal of the switch 18 is connected to second receiving circuit 22. And, switching control of these switches 13 to 18 is carried out by a switch control means (not shown).

Operation of the dual band transmitting/receiving device 200 of the above-described configuration is described. For instance, in the case that the dual band transmitting/receiving device 200 operates with 5 GHz band, only the first transmitting circuit 19 and the first receiving circuit 20 take action, and the second transmitting circuit 21 and the second receiving circuit 22 halt. And at the time of transmission, via the switches 15 and 13, the first transmitting circuit 19 is connected to the first antenna 11, so that the transmission is carried out. While, at the time of reception, the first receiving circuit 20 is connected to the first antenna 11 via switches 17, 15 and 13 or the first receiving circuit 20 is connected to the second antenna 12 via the switches 17 and 14. The reception is carried out by using antenna, whichever has the higher receiving sensitivity.

Likewise, in the case that the dual band transmitting/receiving device 200 operates with 2.4 GHz band, only the second transmitting circuit 21 and the second receiving circuit 22 take action, and the first transmitting circuit 19 and the first receiving circuit 20 halt. And at the time of transmission, via the switches 16 and 14, the second transmitting circuit 21 is connected to the second antenna 12, so that the transmission is carried out. While, at the time of reception, the second receiving circuit 22 is connected to the second antenna 12 via switches 18, 16 and 14 or the second receiving circuit 22 is connected to the first antenna 11 via the switches 18 and 13. The reception is carried out by using antenna, whichever has the higher receiving sensitivity.

Thus, in the dual band transmitting/receiving device 200 shown in FIG. 3, the transmission and the diversity reception become possible with the either IEEE 802.11a communication standard or IEEE 802.11b communication standard (for example, Official gazette of Japanese Laid-Open Patent Publication No. 2003-169008).

However, the above described conventional dual band transmitting/receiving device 200, in the transmission/reception using both the communication standards, has a problem that insertion loss caused by the two or more switches becomes large. Specifically, in the transmission/reception with both communication standards, more than two switches should be provided for a path up to the each transmitting circuit or up to the each receiving circuit from each antenna, so that it is necessary for the signaling path to provide the two or more switches. The switch insertion loss, depending on element characteristic employed, is of approximately 1.0 dB per one switch. At the time of transmission, amplification power increases, so that it avoids realization of low consumption power, while at the time of reception, it becomes a cause of sensitivity degradation. Further, the numerous numbers of the switches has caused disadvantage in manufacturing cost.

Furthermore, there is the case where two switches or three switches are employed in the diversity reception depending on two antennas. Three-switch case has more loss than two-switch case. The diversity reception is carried out while inevitably selecting the antenna with high reception level at the receiving circuit after the loss is generated. As a result, there has been a fear that it is not possible to precisely select the antenna with high reception level originally from between the antennas before the loss is generated, so that the antenna with high reception level originally is not necessarily selected.

### SUMMARY OF THE INVENTION

The present invention has been achieved in consideration of the above-mentioned problem, and an object of the present invention is to provide a dual band transmitting/receiving device in a state that the number of the switches is small, an insertion loss of the switch is small, and it is possible to accurately carry out the diversity reception.

In accordance with the present invention, there is provided a dual band transmitting/receiving device which has a first antenna and a second antenna each capable of performing transmission/reception of signals in two different frequency bands of a first and a second frequency bands, a first transmitting circuit and a first receiving circuit employed in the first frequency band, and a second transmitting circuit and a second receiving circuit employed in the second frequency band, wherein the dual band transmitting/receiving device comprises a first switch for connecting the first antenna to the first receiving circuit, a second switch for connecting the second antenna to the first receiving circuit, a third switch for connecting the first antenna to the second receiving circuit, a fourth switch for connecting the second antenna to the second receiving circuit, a fifth switch for connecting the either one antenna of the first antenna or the second antenna to the first transmitting circuit, and a sixth switch for connecting the either one antenna of the first antenna or the second antenna to the second transmitting circuit.

Further, in accordance with the present invention, there is provided a dual band transmitting/receiving device which has a first antenna and a second antenna each capable of performing transmission/reception of signals in two different frequency bands of a first and a second frequency bands, a first transmitting circuit and a first receiving circuit employed in the first frequency band, and a second transmitting circuit and a second receiving circuit employed in the second frequency band, wherein the dual band transmitting/receiving device comprises the first switch for connecting the first antenna to the first receiving circuit, the second switch for connecting the second antenna to the first receiving circuit, the third switch for connecting the first antenna to the second receiving circuit, the fourth switch for connecting the second antenna to the second receiving circuit, a seventh switch for connecting the first antenna to the first transmitting circuit, an eighth switch for connecting the second antenna to the first transmitting circuit, a ninth switch for connecting the first antenna to the second transmitting circuit, and a tenth switch for connecting the second antenna to the second transmitting circuit.

Further, in accordance with the present invention, there is provided a dual band transmitting/receiving device, which has a first antenna and a second antenna each capable of performing transmission/reception of signals in two different frequency bands of a first and a second frequency bands, a first transmitting circuit and a first receiving circuit employed in the first frequency band, and a second transmitting circuit and a second receiving circuit employed in the second frequency band, in a state where a switch is respectively provided for a path up to each receiving circuit from each antenna, wherein the dual band transmitting/receiving device comprises a switch, which is respectively provided for a first path up to the first receiving circuit from the first antenna, a second path up to the first receiving circuit from the second antenna, a third path up to the second receiving circuit from the first antenna, and a fourth path up to the second receiving circuit from the second antenna, wherein the number of the switch is one each.

In accordance with the present invention in the dual band transmitting/receiving device, it is arranged such that a diversity reception is capable of being carried out while selecting either of the first path or the second path by switch control; and it is arranged such that a diversity reception is capable of being carried out while selecting either of the third path or the fourth path by switch control.

Further, in accordance with the present invention, in the dual band transmitting/receiving device, the switch is respectively provided on a fifth path up to the first antenna from the first transmitting circuit, and a sixth path up to the second antenna from the second transmitting circuit, in a state where the number of the switch provided on the fifth path and the sixth path is one each.

Furthermore, in accordance with the present invention, in the dual band transmitting/receiving device, the switch is respectively provided on a seventh path up to the second antenna from the first transmitting circuit, and an eighth path up to the first antenna from the second transmitting circuit, in a state where the number of the switch provided on the seventh path and the eighth path is one each.

According to the dual band transmitting/receiving device, a configuration is that the each signaling path between the each antenna and the each receiving circuit or transmitting circuit is provided with the only one switch. As a result, the antenna with high receiving level in the antenna itself can be originally selected in antenna selection of the diversity reception in such a way as to minimize the insertion loss caused by the switch while reducing the number of the switch, and the degree of magnitude of the insertion loss is made identical.

### BRIEF DESCRIPTION OF THE DRAWINGS

The features of the present invention which are believed to be novel are set forth with particularity in the appended claims. The invention, together with further objects and advantages thereof, may best be understood by making reference to the following description taken in conjunction with the accompanying drawings, in the several figurers of which like referenced numerals identify like elements, and wherein:

FIG. 1 is a circuit diagram showing a configuration of a dual band transmitting/receiving device 100 of an embodiment 1 according to the present invention;

FIG. 2 is a circuit diagram showing a configuration of a dual band transmitting/receiving device 110 of an embodiment 2 according to the present invention; and

FIG. 3 is a circuit diagram showing the configuration of the conventional dual band transmitting/receiving device 200.

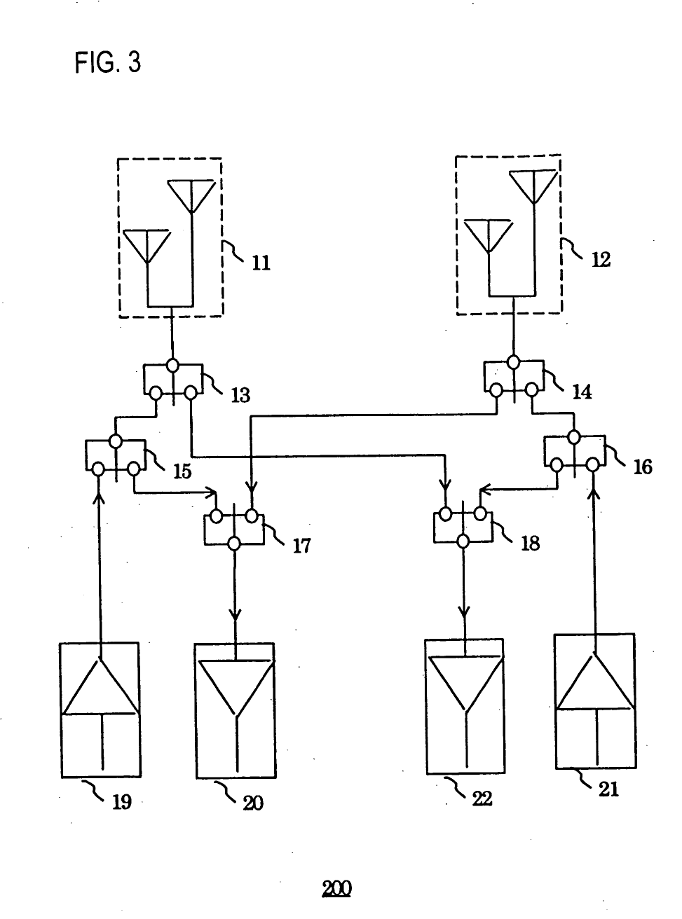

### DETAILED DESCRIPTION OF THE INVENTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be utilized, and other changes may be made, without departing from the spirit or scope of the present invention. The following detailed description is therefore not to be taken in a limiting sense, and the scope of the present invention is defined by the appended claims.

The meaning of “a”, “an”, and “the” include plural references. Additionally, a reference to the singular includes a reference to the plural unless otherwise stated or inconsistent with the disclosure herein.

Hereinafter, a preferred embodiment of the present invention will be described with reference to accompanying drawings. In these embodiments, an object to carry out reduction both of the number of an antenna changeover switch in the dual band transmitting/receiving device and an insertion loss is realized by thinking out a switch connecting method between the antenna and the transmitting/receiving circuit.

In the following respective embodiments, only one switch is respectively arranged between the each antenna and the each receiving circuit, and between the each antenna and the each transmitting circuit. The each switch is of either single-pole single-throw switch.

[Embodiment 1]

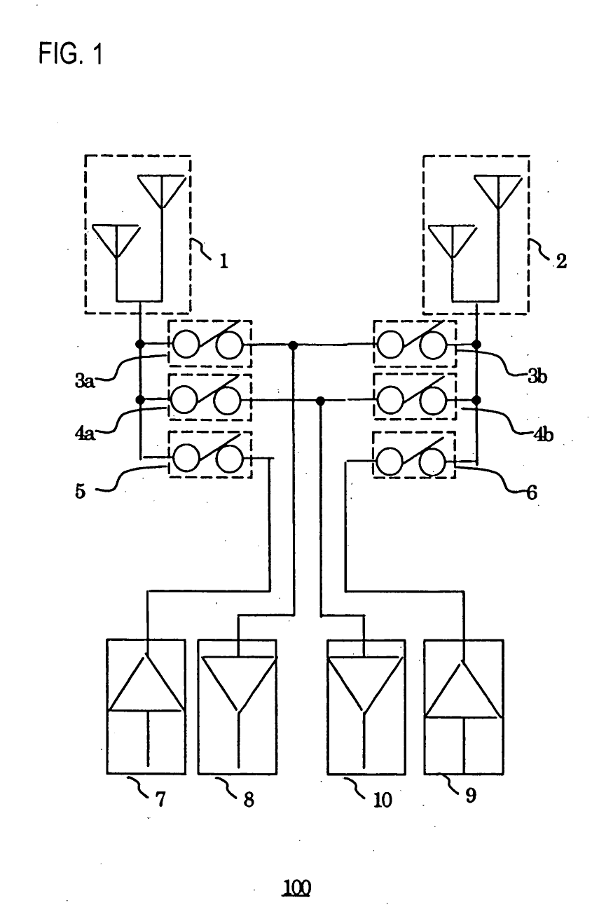

Hereinafter, the dual band transmitting/receiving device 100 of the embodiment 1 of the present invention will be described with reference to FIG. 1. In FIG. 1, the antennas 1 and 2, which are capable of being employed in both 5 GHz band used in the IEEE 802.11a communication standard and 2.4 GHz band used in the IEEE 802. 11b communication standard, the antennas 1 and 2 are of the dual band antennas.

The switches 3a, 3b, 4a, 4b, 5, and 6 are of the first, the second the third, the fourth, the fifth and the sixth switches for respectively switching the antennas, and are of the high frequency switches for opening/closing signaling path between two terminals.

The reference numerals 7 and 8 respectively indicate the first transmitting circuit and the first receiving circuit with the IEEE 802.11a communication standard, and the reference numerals 9 and 10 respectively indicate the second transmitting circuit and the second receiving circuit under the IEEE 802.11b communication standard.

The first receiving circuit 8 is connected to the first antenna 1 via the switch 3a and connected to the second antenna 2 via the switch 3b. Further the second receiving circuit 10 is connected to the first antenna 1 via the switch 4a and connected to the second antenna 2 via the switch 4b.

Furthermore, the first transmitting circuit 7 is connected to the first antenna 1 via the switch 5, and the second transmitting circuit 9 is connected to the second antenna 2 via the switch 6. And switch control means (not shown) carries out switch control of these switches 3a, 3b, 4a, 4b, 5 and 6.

There will be described an operation of the above configured dual band transmitting/receiving device 100. For instance, when the dual band transmitting/receiving device 100 is used with the 5 GHz, only the first transmitting circuit 7 and the first receiving circuit 8 operate, while the second transmitting circuit 9 and the second receiving circuit 10 halt. And, at the time of transmission, only the switch 5 is closed, and the first transmitting circuit 7 is connected to the first antenna 1 to be carried out transmission. While at the time of reception, only the switch 3a is closed where the first receiving circuit 8 is connected to the first antenna 1, or only the switch 3b is closed where the first receiving circuit 8 is connected to the second antenna 2, so that the reception is carried out by using the antenna, whichever has the higher receiving sensitivity.

Similarly, when the dual band transmitting/receiving device 100 is used with the 2.4 GHz, only the second transmitting circuit 9 and the second receiving circuit 10 operate, while the first transmitting circuit 7 and the first receiving circuit 8 halt. And, at the time of transmission, only the switch 6 is closed, and the second transmitting circuit 9 is connected to the second antenna 2 to be carried out transmission. While at the time of reception, only the switch 4a is closed where the second receiving circuit 10 is connected to the first antenna 1, or only the switch 4b is closed where the second receiving circuit 10 is connected to the second antenna 2, so that the reception is carried out by using the antenna, whichever has the higher receiving sensitivity.

Thus, in the dual band transmitting/receiving device 100 shown in FIG. 1, the transmission and the diversity reception become possible with the either of IEEE 802.11a communication standard or IEEE 802.11b communication standard.

As described above, in the dual band transmitting/receiving device 100, only one switch is sufficient in the transmission/reception of the both communication standards up to the each transmitting circuit or the each receiving circuit from the each antenna, so that it is possible to reduce the insertion loss caused by the switch into not more than half as compared with the conventional way, and it is possible to suppress the amplification power corresponding to one at the time of transmission to save low consumption power. And at the time of reception, it is possible to prevent from sensitivity deterioration. Further, with respect to the number of the switches, it is necessary for the conventional dual band transmitting/receiving device 200 to provide 6 pieces of the single-pole double-throw switches (=12 pieces as the number of the switch element), on the contrary, in the case of the dual band transmitting/receiving device 100, six pieces of the switches (=6 pieces as the number of the switch element) are generally sufficient, it becomes advantageous in the manufacturing cost.

Further, in the diversity reception with two antennas, it is possible to unify the number of switch into one that is provided between the antenna and the transmitting or receiving circuit. It becomes possible to accurately select the antenna with high reception level in the antenna selection upon carrying out the diversity reception while selecting the antenna with higher reception level originally in the receiving circuit after the loss is generated.

[Embodiment 2]

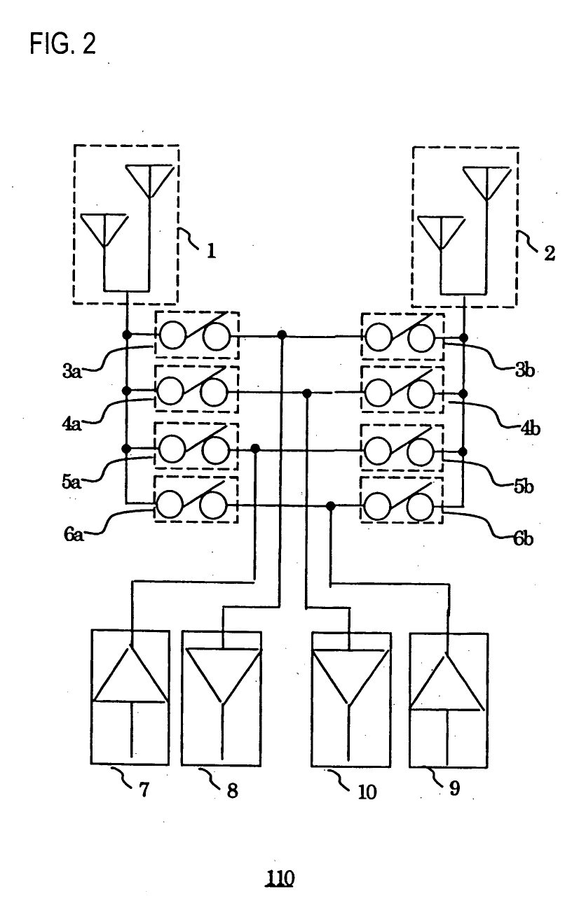

Next, a dual band transmitting/receiving device 110 of an embodiment 2 according to the present invention will be described with reference to FIG. 2. In the drawing, the same component as that of FIG. 1 is made to append the same sign to omit repeated description. The dual band transmitting/receiving device 110 differs from the dual band transmitting/receiving device 100 shown in FIG. 1 in that the first transmitting circuit 7 is also capable of being connected to the second antenna 2, and the second transmitting circuit 9 is also capable of being connected to the first antenna 1.

In FIG. 2, switches 5a, 5b, 6a, and 6b are of the seventh, the eighth, the ninth and the tenth switches for switching each antenna, and are high-frequency switches for opening and closing signaling path between two terminals. The first transmitting circuit 7 is connected to the first antenna 1 via the switch 5a and connected to second antenna 2 via the switch 5b. Further, the second transmitting circuit 9 is connected to the first antenna 1 via the switch 6a and connected to the second antenna 2 via the switch 6b. And, the switch control means (not shown) carries out switch control of switches 3a, 3b, 4a, 4b, 5a, 5b, 6a, and 6b.

There will be described an operation of the above configured dual band transmitting/receiving device 110. For instance, when the dual band transmitting/receiving device 110 is used with 5 GHz, only the first transmitting circuit 7 and the first receiving circuit 8 operate, and the second transmitting circuit 9 and the second receiving circuit 10 halt. Specifically, at the time of transmission, the first transmitting circuit 7 is connected to the first antenna 1 with only the switch 5a closed or the first transmitting circuit 7 is connected to the second antenna 2 with only the switch 5b closed, so that transmission is carried out by using the antenna, whichever is the better radio wave state. On the other hand, at the time of reception, the first receiving circuit 8 is connected to the first antenna 1 with only the switch 3a closed, or the first receiving circuit 8 is connected to the second antenna 2 with only the switch 3b closed, so that reception is carried out by using the antenna, whichever is the higher receiving sensitivity.

Likewise, when the dual band transmitting/receiving device 110 is used with 2.4 GHz band, the second transmitting circuit 9 and the second receiving circuit 10 operate, while the first transmitting circuit 7 and the first receiving circuit 8 halt. Specifically, at the time of transmission, the second transmitting circuit 9 is connected to the first antenna 1 with only the switch 6a closed, or the second transmitting circuit 9 is connected to the second antenna 2 with only the switch 6b closed, so that transmission is carried out by using the antenna, whichever is the better radio wave state. On the other hand, at the time of reception, the second receiving circuit 10 is connected to the first antenna 1 with only the switch 4a closed, or the second receiving circuit 10 is connected to the second antenna 2 with only the switch 4b closed, so that reception is carried out by using the antenna, whichever is the better radio wave state.

Thus, in the dual band transmitting/receiving device 110 shown in FIG. 2, it becomes possible to also carry out the diversity transmission with the either the IEEE 802.11a communication standard or the IEEE 802.11b communication standard in addition to the effect of the dual band transmitting/receiving device 100 capable of being carried out diversity reception.

It should be noted that, in the dual band transmitting/receiving devices 100 and 110, instead of the transmitting/receiving circuit corresponding to the IEEE 802.11b communication standard using, for instance, the frequency of 2.4 GHz, it is appropriate to use a transmitting/receiving circuit corresponding to the standard of IEEE 802.11g using with the frequency of the same 2.4 GHz band.

As described above, the embodiments according the present invention are described with reference to the drawing, however, these are exemplification of the present invention and it is also possible to adopt various configurations other than the above descriptions.

For instance, in FIG. 1 and FIG. 2, it is also possible to connect two antennas to one receiving circuit by using a single-pole double-throw switch. Specifically, the switches 3a and 3b, the switches 4a and 4b, the switches 5a and 5b, and the switches 6a and 6b can be also made to replace with the each single-pole double-throw switch. Also, in such a case, the number of the switch provided between the each antenna and the each receiving circuit becomes one.

The dual band transmitting/receiving device of the present invention can be widely adapted to not only the transmitting/receiving device used for the radio LAN, but also the terminal device in which a plurality of frequency bands and a plurality of communication systems are adopted within one device in a state where a plurality of antennas are employed with the antennas appropriately switched.

The preceding description has been presented only to illustrate and describe the invention. It is not intended to be exhaustive or to limit the invention to any precise form disclosed. Many modifications and variations are possible in light of the above teaching.

The described invention was chosen to explain the principles of this invention. The preceding description is intended to enable those skilled in the art to best utilize the invention in various embodiments and with various modifications as are suited to this particular use contemplated.

1. A dual band transmitting/receiving device, which includes a first antenna and a second antenna each capable of performing transmission/reception of signals in two different frequency bands of a first and a second frequency bands, a first transmitting circuit and a first receiving circuit employed in the first frequency band, and a second transmitting circuit and a second receiving circuit employed in the second frequency band, comprising:
a first switch for connecting the first antenna to the first receiving circuit;
a second switch for connecting the second antenna to the first receiving circuit;
a third switch for connecting the first antenna to the second receiving circuit;
a fourth switch for connecting the second antenna to the second receiving circuit;
a fifth switch for connecting an either one antenna of the first antenna or the second antenna to the first transmitting circuit; and
a sixth switch for connecting an either one antenna of the first antenna or the second antenna to the second transmitting circuit.

2. A dual band transmitting/receiving device, which includes a first antenna and a second antenna each capable of performing transmission/reception of signals in two different frequency bands of a first and a second frequency bands, a first transmitting circuit and a first receiving circuit employed in the first frequency band, and a second transmitting circuit and a second receiving circuit employed in the second frequency band, comprising:
a first switch for connecting the first antenna to the first receiving circuit;
a second switch for connecting the second antenna to the first receiving circuit;
a third switch for connecting the first antenna to the second receiving circuit;
a fourth switch for connecting the second antenna to the second receiving circuit;
a seventh switch for connecting the first antenna to the first transmitting circuit;
an eighth switch for connecting the second antenna to the first transmitting circuit;
a ninth switch for connecting the first antenna to the second transmitting circuit; and
a tenth switch for connecting the second antenna to the second transmitting circuit.

3. A dual band transmitting/receiving device, which includes a first antenna and a second antenna each capable of performing transmission/reception of signals in two different frequency bands of a first and a second frequency bands, a first transmitting circuit and a first receiving circuit employed in the first frequency band, and a second transmitting circuit and a second receiving circuit employed in the second frequency band, in a state where a switch is respectively provided for a path up to each receiving circuit from each antenna, comprising:
a switch, which is respectively provided for
a first path up to the first receiving circuit from the first antenna;
a second path up to the first receiving circuit from the second antenna;
a third path up to the second receiving circuit from the first antenna; and
a fourth path up to the second receiving circuit from the second antenna, the number of which is one each.

4. The dual band transmitting/receiving device according to claim 3, wherein it is arranged such that a diversity reception is capable of being carried out while selecting either the first path or the second path by switch control; and it is arranged such that a diversity reception is capable of being carried out while selecting either the third path or the fourth path by switch control.

5. The dual band transmitting/receiving device according to claim 3, wherein the switch is respectively provided for a fifth path up to the first antenna from the first transmitting circuit, and a sixth path up to the second antenna from the second transmitting circuit, in a state where the number of the switch provided for the fifth path and the sixth path is one each.

6. The dual band transmitting/receiving device according to claim 5, wherein the switch is respectively provided on a seventh path up to the second antenna from the first transmitting circuit, and an eighth path up to the first antenna from the second transmitting circuit, in a state where the number of the switch provided on the seventh path and the eighth path is one each.

7. The dual band transmitting/receiving device according to claim 3, wherein the all switch provided for the each path is of a single-pole single-throw switch.
